(19) United States
(12) Patent Application Publication
(10) Pub. No.: US 2008/0239892 A1
(43) Pub. Date: Oct. 2, 2008

(54) Method and System for Recording Data on an Optical Disc by a Plurality of Laser Beams

(75) Inventors: Dayu Chen, Shanghai (CN); Henk Goossens, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/090,371

(22) PCT Filed: Oct. 12, 2006
(86) PCT No.: PCT/IB06/53745

§ 371 Date: Apr. 16, 2008

(30) Foreign Application Priority Data
Oct. 20, 2005 (CN) 200510108696.0

(51) Int. Cl. G11B 7/00; G11B 7/0045

(52) U.S. Cl. 369/44.28

(57) ABSTRACT

The invention relates to a system and method of recording data on an optical disc by a plurality of laser beams positioned along inner tracks to outer tracks of said optical disc, said optical disc comprising segments each being identified by a start of segment, said method comprising the steps of: switching writing on (710) successively each laser beam at different starts of segments for recording data, switching writing off (720) successively each laser beam arriving at the start of a segment previously recorded by another laser beam, detecting (730) when only one laser beam remains writing on, detecting (740) a subsequent start of a segment accessed by said one laser beam, switching writing off (750) said one laser beam, shifting (760) all the laser beams so that the innermost laser beam gets positioned at said subsequent start.

### FIELD OF THE INVENTION

The invention relates to a method and system for recording data on an optical disc by a plurality of laser beams.

### BACKGROUND OF THE INVENTION

With the development of optical storage solutions and the increasing data capacity of the optical discs, such as DVD (digital versatile disc), VCD (video compact disc), or BD (Blu-ray disc), the speed of recording data on said optical discs has become a key factor.

Some techniques are known for recording data on an optical disc at high speed, in particular techniques using a plurality of laser beams working in parallel. Such techniques propose that the plurality of laser beams are controlled so as to simultaneously record data on an optical disc, then simultaneously shift to a next position after said plurality of laser beams has rotated by pre-defined angle, such as a multiple of 360°.

These known techniques have some major limitations. Indeed, when the plurality of laser beams is shifted by said pre-defined angle, the new data sequence to be recorded by each laser beam is likely located inside a segment of an optical disc (pre-defined area on the spiral track of an optical disc). This implies that the laser beams must be controlled at a high precision of less than a channel bit length for linking consecutive data sequences to be recorded. Reaching this high precision is not only difficult to achieve, but also expensive. Moreover, if this high precision is not reached, consecutive recorded data sequences cannot be linked seamlessly, leading to recording errors because of overlapping in data sequences data, and/or to data lost.

### OBJECT AND SUMMARY OF THE INVENTION

It is an object of the invention to provide an improved method and system for recording data on an optical disc by a plurality of laser beams.

The method according to the invention is intended to record data on an optical disc by a plurality of laser beams positioned along inner tracks to outer tracks of said optical disc, said optical disc comprising segments each being identified by a start of segment. Said method comprising the steps of:
switching writing on successively each laser beam at different starts of segments for recording data,
switching writing off successively each laser beam arriving at the start of a segment previously recorded by another laser beam,
detecting when only one laser beam remains writing on,
detecting a subsequent start of a segment accessed by said one laser beam,
switching writing off said one laser beam, and
shifting all the laser beams so that the innermost laser beam gets positioned at said subsequent start if the recording is done from inner tracks to outer tracks, or shifting all the laser beams so that the outermost laser beam gets positioned at said subsequent start if the recording is done from outer tracks to inner tracks.

The invention also proposes a system comprising processing means for implementing the different steps of said method according to the invention.

This method and system are advantageous since the laser beams, after shifting, start recording from the starts of segments and by one whole segment at one time, which requires a lower precision compared to that of the prior art, since a precision in the wobble wavelength order is sufficient. As a result, consecutive data sequences can be recorded by a plurality of laser beams without data overlapping data and data lost.

### BRIEF DESCRIPTION OF THE DRAWINGS

These and other aspects of the method and system for recording data on an optical disc by a plurality of laser beams, according to the invention will become apparent from and will be elucidated with respect to the implementations and embodiments described hereinafter and with reference to the accompanying drawings, wherein:

FIG. 1 to FIG. 6 illustrate by an example, different and consecutive states resulting from the steps of the method according to the invention,

FIG. 7 depicts a flow chart of the method of recording data on an optical disc by a plurality of laser beams according to the invention,

FIG. 8 depicts a system for implementing the method according to the invention previously described.

Same reference numerals are used to denote similar parts throughout the figures.

### DETAILED DESCRIPTION OF THE INVENTION

For sake of understanding, the invention will first be explained via an example using two laser beams, then secondly generalized to a plurality of laser beams.

During the recording process, the optical disc and the laser beams have a relative rotation movement. The optical disc comprises segments intended to store data and defined along the spiral tracks on the optical disc. Each segment is identified by a start of segment detected by a structure on the optical disc.

In the following, the innermost laser beam designates the laser beam positioned on the innermost track of the optical disc, while the outermost laser beam designates the laser beam positioned on the outermost track of the optical disc.

In the following, the laser beams have at the same time, the same relative angular variation compared to the optical disc.

In the following, a laser beam “switched off” will refer to a state where the writing/recording process is “off”, i.e. not activated, e.g. a laser beam is not applied on the optical disc or a laser beam is applied on the optical disc in read mode. A laser beam “switched on” will refer to a state where the writing/recording process is “on”, i.e. activated, namely, the laser beam is in writing/recording mode.

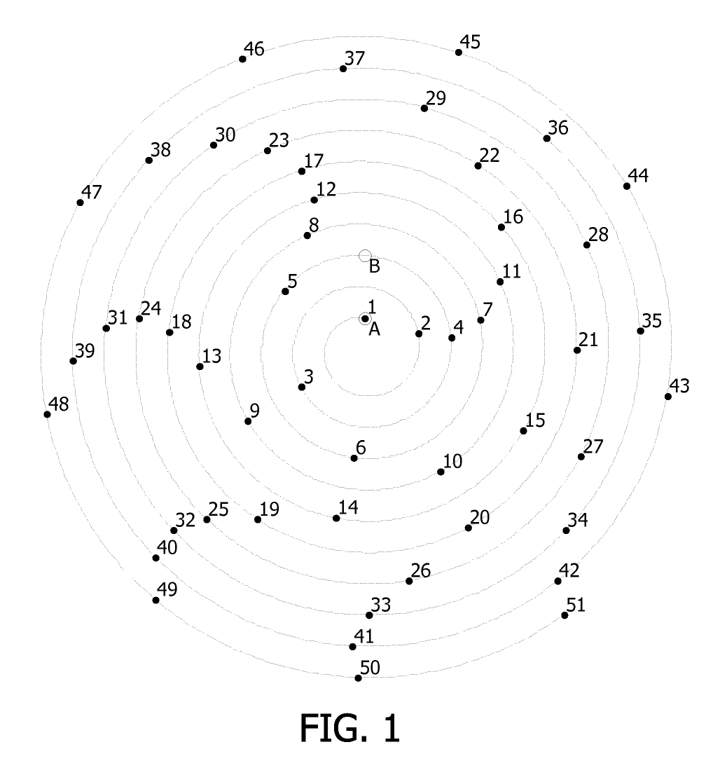

FIG. 1 to FIG. 6 illustrate by an example, different and consecutive states resulting from the steps of the method according to the invention, via the use of two laser beams A and B applied to the optical disc so as to record data in parallel.

In this example, the innermost laser beam is laser beam A, and the outermost laser beam is laser beam B. The recording is supposed to be done from inner tracks to outer tracks, but it will be apparent for a skilled person that similar explanations apply if the recording is done from outer tracks to inner tracks.

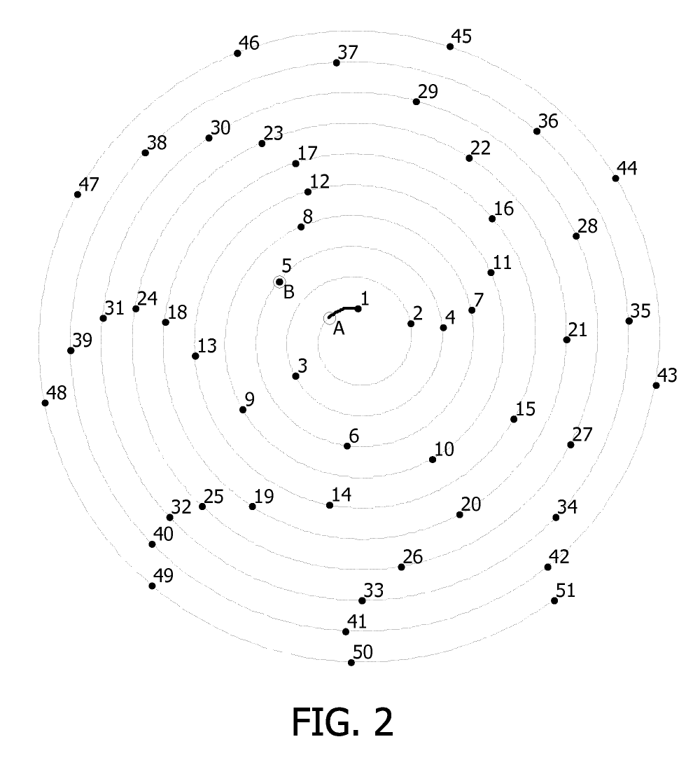

In FIG. 1, at the start of the recording process, the initial position of the laser beam A is located at the start of segment 1, and the initial position of laser beam B is located somewhere inside segment 4. The laser beam A being positioned at the start of segment 1, it is switched on from the start of segment 1. The laser beam B being located inside segment 4, and not locating at a start of a segment, the laser beam B is switched off until the laser beam B arrives at a subsequent start, in this example start 5, as depicted in FIG. 2.

In FIG. 2, the laser beam B arrives at the start of segment 5. The laser beam B being now positioned at a start of a segment, it is switched on from the start of segment 5. The laser beam A is still switched on.

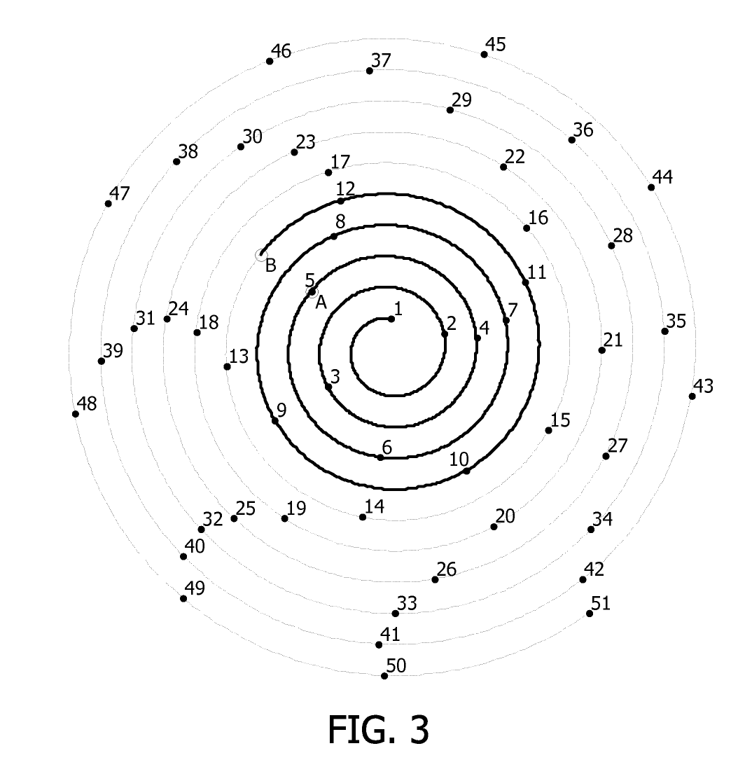

In FIG. 3, the laser beam A arrives the start of segment 5, i.e. the start of a previously recorded segment by another laser beam, namely by laser beam B. To avoid recording over previously recorded data by laser beam B, the laser beam A is switched off. The laser beam B becomes the only remaining laser beam being switched on, until laser beam B arrives at a subsequent start of a segment, such as start of segment 13 in this example (or start of segment 14 . . . ).

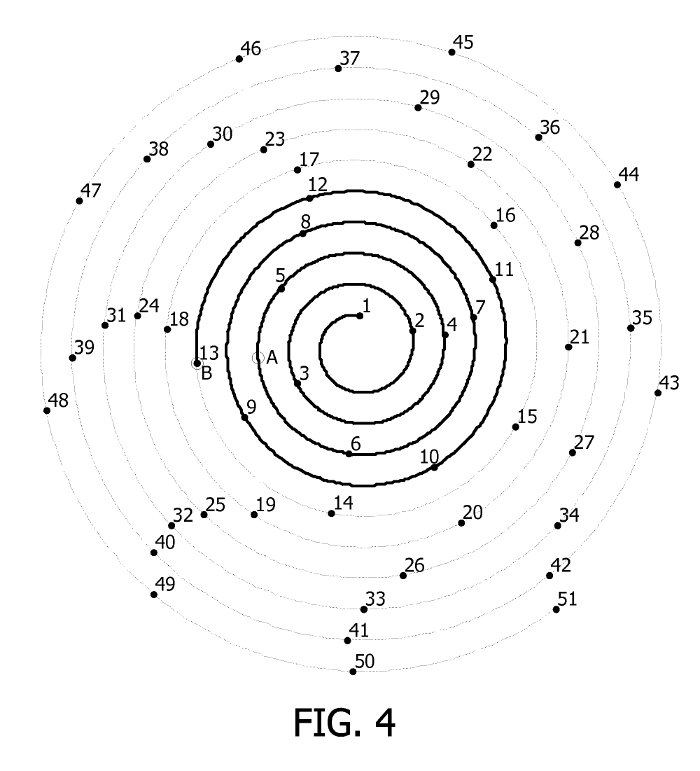

In FIG. 4, the laser beam B arrives at a subsequent start of segment, segment 13 in the example, and is thus switched off. Laser beam A and Laser B being both switched off, they are simultaneously shifted so that laser beam A (i.e. the innermost laser beam) gets positioned at said subsequent start of segment 13, i.e. gets positioned at a start of a segment where laser beam B has switched off.

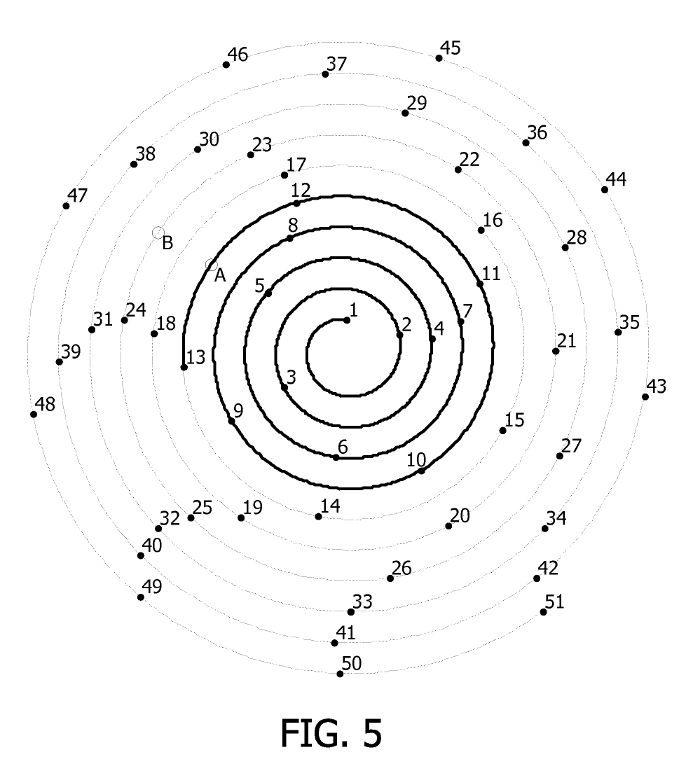

FIG. 5 shows an intermediate state before laser beam A arrives at start of segment 13, just after the shift of the laser beams A and B. Indeed, since the optical disc is rotating and that the shift is not instantaneous, laser beam A actually arrives in a segment situated before the start of segment 13. In this example, laser beam A arrives in segment 12 and laser B arrives in segment 23.

Concerning laser beam A, it is switched on when arriving at the memorized start of segment 13.

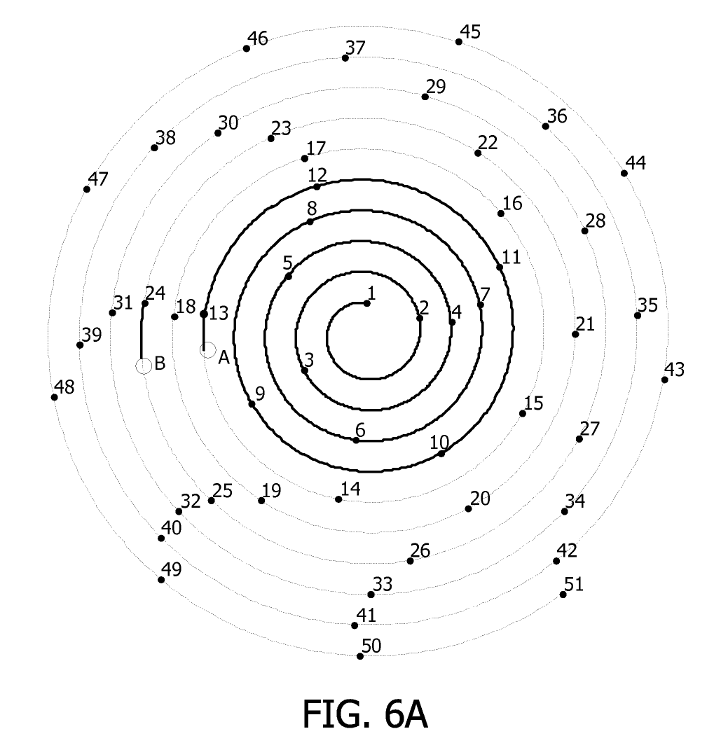

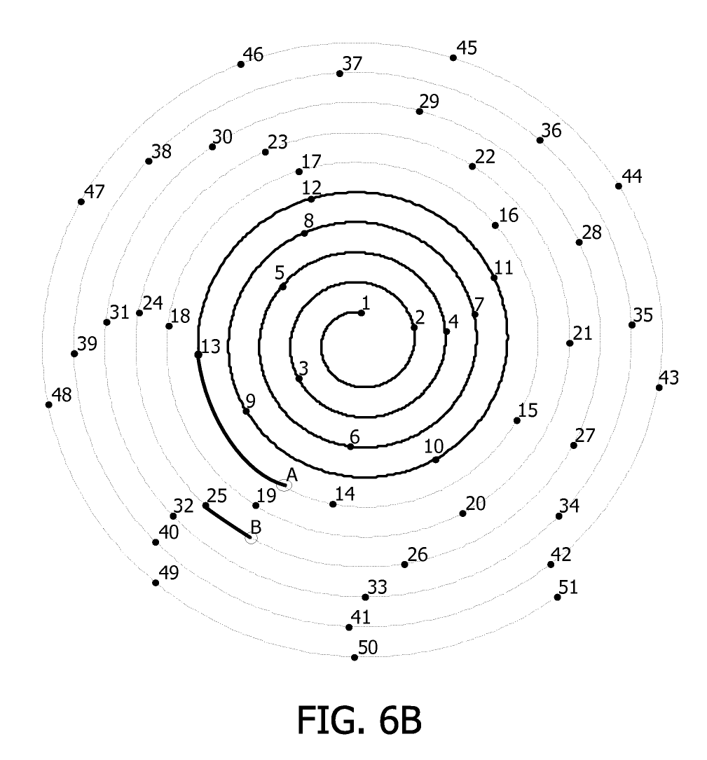

Concerning laser beam B, it is also switched on when arriving at the start of a segment:
either switched on before laser A is switched on, as shown on FIG. 6A where laser beam B is switched on at the beginning of segment 24,
either switched on after laser A is switched on, as shown on FIG. 6B where laser beam B is switched on at the beginning of a next segment 25.

The following of the process is then similar to that described in accordance with FIG. 2.

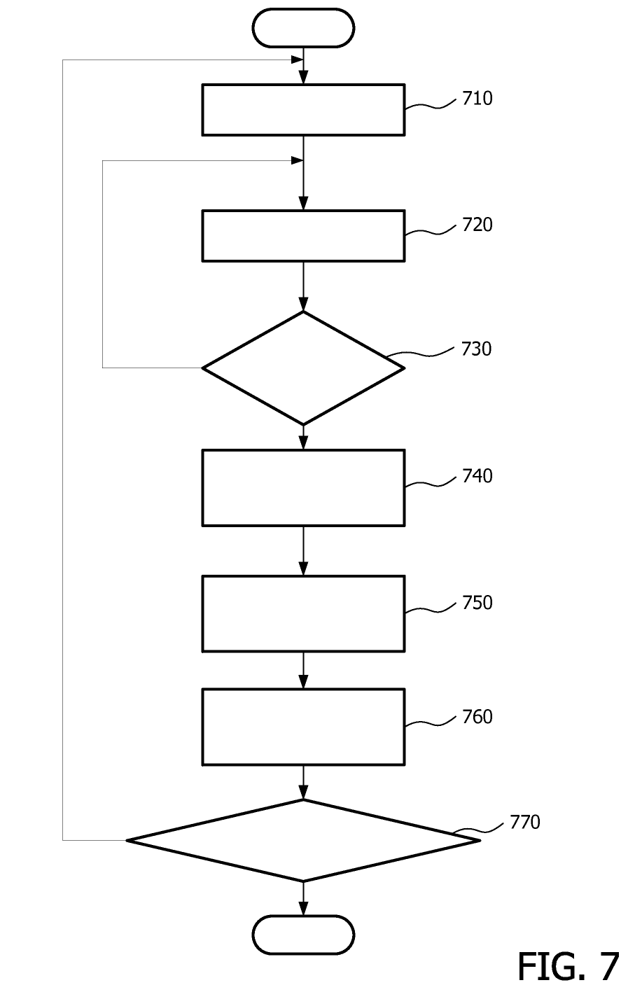

FIG. 7 depicts a flow chart of the method of recording data on an optical disc by a plurality of laser beams according to the invention, the laser beams being positioned along inner tracks to outer tracks of said optical disc, said optical disc comprising segments each being identified by a start of segment. The method comprises the steps of:
switching writing on (710) successively each laser beam at different starts of segments for recording data: This switching can be done on the basis of segment starts detected from pre-groove information of the optical disc or data information recorded on the optical disc previously. The segment start detection being known as such, no further explanations will be given.
switching writing off (720) successively each laser beam arriving at the start of a segment previously recorded by another laser beam: This step implies to memorize the previous segment starts of laser beams when they are switched on.
detecting (730) when only one laser beam remains writing on: As long as more than one laser beam is still switched writing on, the process goes back to step 720.
detecting (740) a subsequent start of a segment accessed by said one laser beam.
switching writing off (750) said one laser beam.
shifting (760) all the laser beams so that the innermost laser beam gets positioned at said subsequent start if the recording is done from inner tracks to outer tracks, or shifting all the laser beams so that the outermost laser beam gets positioned at said subsequent start if the recording is done from outer tracks to inner tracks: This shift implies a simultaneously displacement of all the laser beams, for example via a translation movement along a radial direction of the optical disc.
   According to an additional decision step 770, the process either goes back to step 710, or stops if the criteria of said additional decision step is fulfilled (e.g. no more data to record).

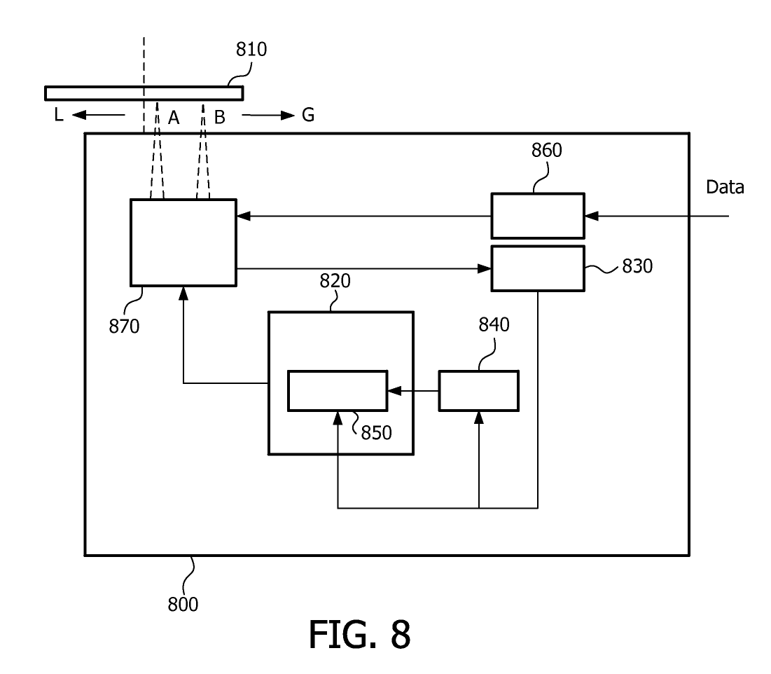

FIG. 8 depicts a system for implementing the method according to the invention previously described. This system is intended to record data on an optical disc 810 by a plurality of laser beams (A, B) positioned along inner tracks to outer tracks of said optical disc, said optical disc comprising segments each being identified by a start of segment. The laser beams are generated by laser unit 870.

This system comprises controlling means 820 for:
a) switching writing on successively each laser beam at different starts of segments for recording data. The start of a segment may for example be detected from pre-groove information of the optical disc or data information recorded on the optical disc, via detector 830. The segment start detection via pre-groove information or data information recorded on the optical disc being known as such, no further explanations will be given. When a given laser beam is switched on, its corresponding segment start is memorized in memory 840.
b) switching writing off successively each laser beam arriving at the start of a segment previously recorded by another laser beam. The start of a segment is detected via detector 830. This change of state may be done on the basis of a comparison via comparator 850 between a previously memorized start of a segment and a current start of a segment.
c) detecting when only one laser beam remains writing on, then for detecting a subsequent start of a segment accessed by said one laser beam, then for switching writing off said one laser beam. The subsequent start is detected via detector 830.
   Data to be recorded are first coded via the coder 860 in charge of modulating the laser pulses of laser A and B generated by the laser unit 870.
   This system also comprises means for shifting simultaneously all the laser beams (A, B) so that the innermost laser beam gets positioned at said subsequent start if the recording is done from inner tracks to outer tracks, or for shifting all the laser beams so that the outermost laser beam gets positioned at said subsequent start if the recording is done from outer tracks to inner tracks.
   This shift implies a simultaneous displacement of all the laser beams (A, B), for example via a translation movement along a radial direction of the optical disc, as illustrated by arrows L and G. For example, the shift could be done via similar actuations means (not shown) usually in charge of displacing a laser beams along the radial direction, under the control of the controlling means 820.
   This system may advantageously be integrated in a recorder for optical disc (e.g. computer disc drive, standalone apparatus . . . ).

It should be noted that the above-mentioned embodiments illustrate rather than limit the invention and that those skilled in the art will be able to design alternative embodiments without departing from the scope of the appended claims. In the claims, any reference signs placed between parentheses shall not be constructed as limiting the claim. The word ‘comprising’ does not exclude the presence of elements or steps not listed in a claim. The word “a” or “an” preceding an element does not exclude the presence of a plurality of such elements. The invention can be implemented by means of hardware comprising several distinct elements and by means of a suitable programmed computer. In the unit claims enumerating several means, several of these means can be embodied by one and the same item of hardware. The usage of the words first, second and third, etcetera do not indicate any ordering. These words are to be interpreted as names.

1. A method of recording data on an optical disc by a plurality of laser beams positioned along inner tracks to outer tracks of said optical disc, said optical disc comprising segments each being identified by a start of segment, said method comprising the steps of:
switching writing on (710) successively each laser beam at different starts of segments for recording data,
switching writing off (720) successively each laser beam arriving at the start of a segment previously recorded by another laser beam,
detecting (730) when only one laser beam remains writing on,
detecting (740) a subsequent start of a segment accessed by said one laser beam,
switching writing off (750) said one laser beam, and
shifting (760) all the laser beams so that the innermost laser beam gets positioned at said subsequent start if the recording is done from inner tracks to outer tracks, or shifting all the laser beams so that the outermost laser beam gets positioned at said subsequent start if the recording is done from outer tracks to inner tracks.

2. A method as claimed in claim 1, wherein the starts of segments are detected from pre-groove information of said optical disc or data information recorded on said optical disc.

3. A system for recording data on an optical disc (810) by a plurality of laser beams (A, B) positioned along inner tracks to outer tracks of said optical disc, said optical disc comprising segments each being identified by a start of segment, said system comprising:
controlling means (820) for:
a) switching writing on successively each laser beam at different starts of segments for recording data,
b) switching writing off successively each laser beam arriving at the start of a segment previously recorded by another laser beam,
c) detecting when only one laser beam remains writing on, then for detecting a subsequent start of a segment accessed by said one laser beam, then for switching writing off said one laser beam,
means for shifting all the laser beams (A, B) so that the innermost laser beam gets positioned at said subsequent start if the recording is done from inner tracks to outer tracks, or for shifting all the laser beams so that the outermost laser beam gets positioned at said subsequent start if the recording is done from outer tracks to inner tracks.

4. A system as claimed in claim 3, further comprising a detector (830) for detecting the starts of segments from pre-groove information of said optical disc or data information recorded on said optical disc.

5. A recorder for recording an optical disc, said recorder comprising a system as claimed in claim 3.
